(19) United States
(12) Patent Application Publication
(10) Pub. No.: US 2019/0056688 A1
(43) Pub. Date: Feb. 21, 2019

(54) FORMING APPARATUS, AND MANUFACTURING METHOD OF THREE-DIMENSIONAL OBJECT

(71) Applicant: CANON KABUSHIKI KAISHA, Tokyo (JP)

(72) Inventors: Yuji Wakabayashi, Funabashi-shi (JP); Tatsuya Tada, Yokohama-shi (JP); Hirokazu Usami, Yokohama-shi (JP); Kenji Karashima, Tokyo (JP); Genya Anan, Inagi-shi (JP); Takashi Kase, Tokyo (JP); Satoru Yamanaka, Kawasaki-shi (JP)

(21) Appl. No.: 16/168,654

(22) Filed: Oct. 23, 2018

Related U.S. Application Data
(63) Continuation of application No. PCT/JP2017/016047, filed on Apr. 21, 2017.

(30) Foreign Application Priority Data
Apr. 28, 2016 (JP) 2016-091577

(51) Int. Cl. G03G 15/22; B29C 64/141; B29C 64/227; G03G 15/20; G03G 15/16; B29C 64/205

(52) U.S. Cl. CPC G03G 15/224; B29C 64/141; B29C 64/227; B33Y 10/00; G03G 15/1625; B29C 64/205; G03G 15/2021

(57) ABSTRACT

Occurrence of layering defects is suppressed in a layering forming method where material layers on a conveyance member are heated and layered. A forming apparatus 1 configured to sequentially layer a plurality of material layers and form a three-dimensional object includes a stage having a forming face on which the material layers are layered, a conveyance member configured to support and convey the material layers to a layering position facing the forming face, and a heating member configured to nip the material layers between itself and the forming face of the stage at the layering position, and pressurize and heat the material layer. When a heating region of the heating member is perpendicularly projected onto a plane where a supporting face at which the conveyance member supports the material layer exists, a projection plane of the heating region has extending regions that extend further to the outer side from both edges of the supporting face, on both edges of the projection plane of the heating region.

### CROSS-REFERENCE TO RELATED APPLICATIONS

This application is a Continuation of International Patent Application No. PCT/JP2017/016047, filed Apr. 21, 2017, which claims the benefit of Japanese Patent Application No. 2016-091577, filed Apr. 28, 2016, both of which are hereby incorporated by reference herein in their entirety.

### TECHNICAL FIELD

The present invention relates to a forming apparatus and a manufacturing method of a three-dimensional object.

### BACKGROUND ART

The layering forming method, where a three-dimensional object is formed by building up a great number of layers, is gathering attention. The layering forming method is also referred to as additive manufacturing (AM), three-dimensional printing, rapid prototyping (RP), and so forth.

PTL 1 discloses a forming apparatus of a type where material layers are formed, and formed material layers are layered, as a forming apparatus that forms three-dimensional objects by the layering forming method. With the forming apparatus described in PTL 1, material layers are formed by electrophotography on a belt that is a conveyance member. Thereafter, the material layers are conveyed to a layering position, and layered on a stage or on a partly formed three-dimensional object that is being formed on the stage. A desired three-dimensional object is formed by repeating this operation.

In PTL 1, once a material layer is conveyed to the layering position, the forming apparatus drives the belt or stage so that the material layer on the belt and the stage or on the partly formed three-dimensional object that is being formed on the stage come into contact. The material layer is then heated via the belt in this state, thereby applying heat and pressure to the material layer and the three-dimensional object partway formed, thus layering the material layer.

### CITATION LIST

### Patent Literature

PTL 1 Japanese Patent Laid-Open No. 8-511217

Although no clear description is made regarding the width of the heating portion that heats the material layer on the belt and the width of the belt for the forming apparatus described in PTL 1, the drawings are drawn such that the width of the heating portion is equal to the width of the belt or smaller. In a case where the width of the heating portion is equal to the width of the belt or smaller, there is a possibility that the belt will not be uniformly heated, and variation in temperature will occur in the heated face.

There has been a problem that when such variation in temperature occurs in the heated face, there is a possibility that warping of the belt will occur, and defective layering may occur.

It has been found desirable to suppress occurrence of defective layering in the layering forming method where material layers on a conveyance member are heated and layered.

### SUMMARY OF INVENTION

A forming apparatus to one aspect of the present invention is a forming apparatus configured to sequentially layer a plurality of material layers and form a three-dimensional object. The forming apparatus includes: a stage having a forming face on which the material layers are layered; a conveyance member configured to support and convey the material layers to a layering position facing the forming face; and a heating member configured to heat the material layer; pressurizing means configured to nip the material layers between the forming face of the stage and the heating member at the layering position, and pressurize and heat the material layer, wherein, when a heating region of the heating member is perpendicularly projected onto a plane where a supporting face, at which the conveyance member supports the material layer, exists, a projection plane of the heating region has extending regions that extend further to the outer side from both edges of the supporting face, on both edges of the projection plane.

Further features of the present invention will become apparent from the following description of exemplary embodiments with reference to the attached drawings.

### BRIEF DESCRIPTION OF DRAWINGS

FIG. 1 is a diagram schematically illustrating the configuration of a forming apparatus according to a first embodiment.

FIG. 2 is a diagram schematically illustrating a modification of a material layer forming unit.

FIGS. 3A and 3B are diagrams schematically illustrating a particle image forming unit and developing device.

FIG. 4 is a flowchart illustrating an operation sequence in a forming processing by the forming apparatus according to the first embodiment.

FIGS. 5A through 5C are diagrams schematically illustrating the relationship between a heating member and conveyance member at a layering position, in a forming apparatus according to a first comparative embodiment.

FIGS. 6A through 6C are diagrams schematically illustrating the relationship between a heating member and conveyance member at a layering position, in a forming apparatus according to a second comparative embodiment.

FIGS. 7A through 7C are diagrams schematically illustrating the relationship between a heating member and conveyance member at a layering position, in the forming apparatus according to the first embodiment.

FIGS. 8A through 81 are diagrams schematically illustrating a layering process in the first embodiment, first comparative embodiment, and second comparative embodiment.

FIG. 9 is a diagram schematically illustrating the configuration of a forming apparatus according to a second embodiment.

FIGS. 10A through 10C are diagrams schematically illustrating the relationship between a heating member and conveyance member at a layering position, in the forming apparatus according to the second embodiment.

FIGS. 11A through 11C are diagrams schematically illustrating the relationship between a heating member and conveyance member at a layering position, in a forming apparatus according to a modification of the second embodiment.

FIG. 12 is a diagram schematically illustrating the relationship between a heating member, cooling member, and conveyance member at a layering position, in a forming apparatus according to a modification of a third embodiment.

### DESCRIPTION OF EMBODIMENTS

Embodiments for carrying out the invention will be exemplarily described with reference to the drawings. Note that dimensions, materials, forms, and relative placements and so forth of members, procedures of various types of controls, control parameters, target values, and so forth, are not intended to restrict the scope of the invention thereto, unless specifically stated otherwise.

### First Embodiment

Overall Configuration of Forming Apparatus

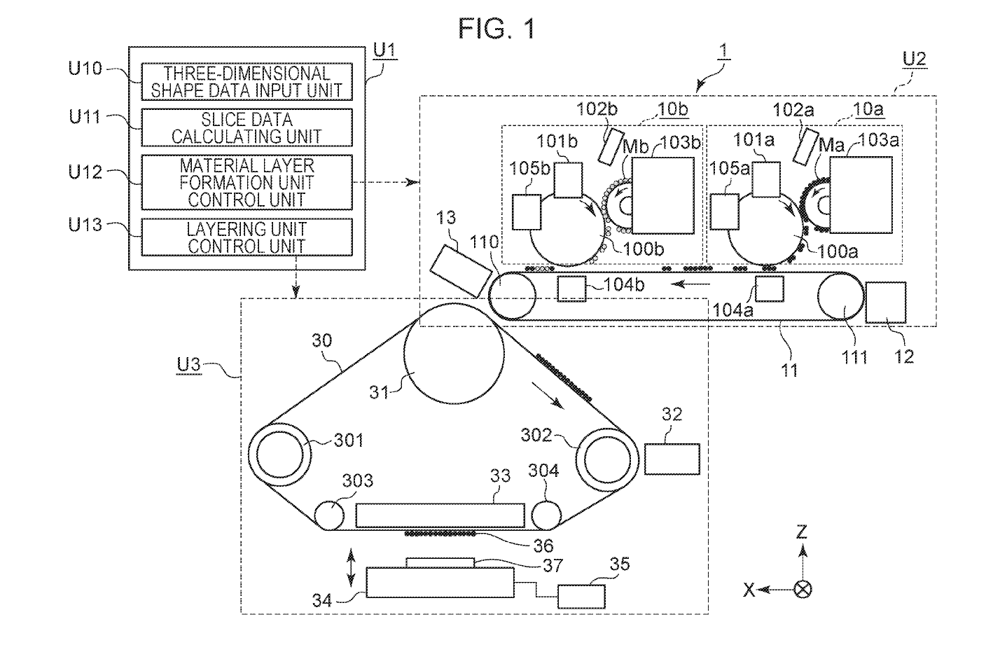

FIG. 1 is a diagram schematically illustrating the configuration of a forming apparatus 1 (hereinafter referred to as “apparatus 1”) according to a first embodiment. The apparatus 1 is an apparatus that sequentially layers multiple material layers at a layering position and forms a three-dimensional object (layering forming apparatus).

The apparatus 1 includes a stage 34, a conveying member 30, a temperature adjusting unit 33, and stage driving means 35, as illustrated in FIG. 1. The apparatus 1 may further include a control part (control unit) U1, a material layer forming part (material layer forming unit) U2. That is to say, the apparatus 1 may include the control unit U1, the material layer forming unit U2, and a layering unit U3 that includes the stage 34, conveying member 30, temperature adjusting unit 33, and stage driving means 35.

The control unit U1 is a unit that performs processing of generating multiple layers of slice data (cross-sectional data) from three-dimensional shape data of an object to be formed, control of various parts of the three-dimensional forming apparatus, and so forth. The material layer forming unit U2 is a unit that forms material layers that are layers made up of a forming material. The layering unit U3 is a unit that forms the three-dimensional object by sequentially layering multiple material layers formed at the material layer forming unit U2 or multiple material layers externally supplied to the apparatus 1.

These units U1 through U3 may have different enclosures from each other, or may be accommodated within a single enclosure. A configuration where the units U1 through U3 are in separate enclosures is advantageous in that units can be easily combined or exchanged or the like in accordance with the usage, required performance, material to be used, installation space, malfunctioning, and so forth, thereby improving the freedom of apparatus configuration and convenience. On the other hand, a configuration where all units are accommodated within a single enclosure is advantageous from the perspective of reduction in size of the overall apparatus, reduction of costs, and so forth. Note that the configuration of units in FIG. 1 is only exemplary, and that other configurations may be employed.

Control Unit

The configuration of the control unit U1 will be described. The control unit U1 has, as functions thereof, a three-dimensional shape data input unit U10, a slice data calculating unit U11, a material layer formation unit control unit U12, a layering unit control unit U13, and so forth, as illustrated in FIG. 1.

The three-dimensional shape data input unit U10 is a function that accepts three-dimensional shape data of an object to be formed from an external device (e.g., a personal computer or the like). Data created by and output from three-dimensional computer-aided design (CAD), a three-dimensional modeler, a three-dimensional scanner, and so forth, can be used as three-dimensional shape data. The file format is not restricted in particular, but a Stereo Lithography (STL) file format can be preferably used.

The slice data calculating unit U11 is a function that slices the object to be formed, expressed in three-dimensional shape data, at a predetermined pitch, and calculates the cross-sectional shape of each layer. Based on the cross-sectional shape, the slice data calculating unit U11 generates image data to be used for forming at the material layer forming unit U2. This image data is referred to as slice image data, or simply slice data, in the present specification. The slice data calculating unit U11 further analyzes the three-dimensional shape data or slice data in upper or lower layers, determines whether there are any overhanging portions (portions floating free), and adds an image of supporting material to the slice data as necessary.

The material layer formation unit control unit U12 is a function that controls the material layer forming process at the material layer forming unit U2, based on the slice data generated by the slice data calculating unit U11.

The layering unit control unit U13 is a function that controls the layering process at the layering unit U3. Specific contents of control at each unit will be described later.

Material Layer Forming Unit

Next, the configuration of the material layer forming unit U2 will be described. the material layer forming unit U2 is a unit that forms material layers that are layers made up of forming material. The method by which the material layer forming unit U2 of the forming apparatus according to the present invention forms material layers is not restricted in particular, but an example of forming material layers using the electrophotography process will be illustrated here. Note that the electrophotography process is a technique to form a desired image by a series of processes where a photosensitive member is charged, a latent image is formed by exposure, and developing agent particles are adhered thereto to form an image from the developing agent.

The material layer forming unit U2 according to the present embodiment has, as illustrated in FIG. 1, a first particle image forming unit 10a, a second particle image forming unit 10b, a first conveyance member 11, a belt cleaning device 12, and a material layer detection sensor 13.

The first particle image forming unit 10a is particle image forming means for forming a particle image using a first forming material Ma, and includes an image bearing member 100a, charging device 101a, an exposing device 102a, a developing device 103a, a transfer device 104a, and a cleaning device 105a.

Also, the second particle image forming unit 10b is particle image forming means for forming a particle image using a second forming material Mb, and includes an image bearing member 100b, a charging device 101b, an exposing device 102b, a developing device 103b, a transfer device 104b, and a cleaning device 105b.

In the present embodiment, a structural material made of a thermoplastic resin or the like is used as the first forming material Ma, and a support material having thermo-plasticity and water-solubility is used as the second forming material Mb. Note that in the present embodiment, a structural material powder that is a powdered structural material is used as the first forming material Ma, and a support material powder that is a powdered support material is used as the second forming material Mb. While the diameter of the particles included in the forming powders (powdered forming materials) is not restricted in particular, but preferably is 5 μm or larger and 50 μm or smaller, and that approximately 20 μm is used in the present embodiment.

Examples of structural material include polyethylene (PE), polypropylene (PP), acrylonitrile butadiene styrene (ABS), polystyrene (PS), polyethylene terephthalate (PET), polyphenylene ether (PPE), nylon/polyamide (PA), polycarbonate (PC), polyacetal (POM), polybutylene terephthalate (PBT), polyphenylene sulfide (PPS), polyether ether ketone (PEEK), liquid crystal polymer (LCP), fluororesin, urethane resin, elastomer, and other such common plastic materials such as general-purpose plastics, engineered plastics, and so forth. Further, metals, inorganic matter, and so forth may be used as structural material.

Also, the support material preferably is a material soluble in a solvent that does not dissolve the structural material, and water-soluble organic materials and water-soluble inorganic materials can be used, for example. Specific examples of water-soluble organic materials include water-soluble saccharides such as monosaccharides, oligosaccharides, polysaccharides, dietary fiber, and so forth, polyactic acid (PLA), polyvinyl alcohol (PVA), polyethylene glycol (PEG), and so forth.

These particle image forming units 10a and 10b are disposed along the surface of a first conveyance member (belt) 11. Note that while the first particle image forming unit 10a for the structural material is illustrated in FIG. 1 as being on the upstream side in the conveyance direction, the order of disposing the particle image forming units is optional.

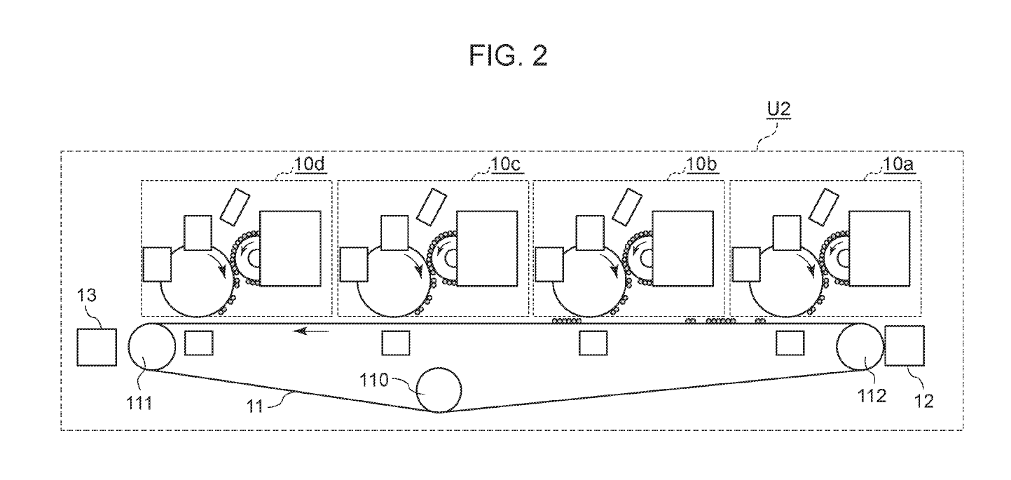

The number of particle image forming units may be greater than two, and can be increased as appropriate in accordance with the types of forming materials being used. For example, FIG. 2 is an example where four first particle image forming units 10a through 10d have been arrayed. In this case, various configurations can be made, such as performing image forming using four types of structural materials, performing image forming using three types of structural materials and a support material, and so forth. A greater variation of generated three-dimensional objects can be obtained by combining materials with different types of materials, colors, hardness, physical properties, and so forth. Such excellent expandability can also be said to be an advantage of a forming apparatus using the electrophotography process.

The following is a detailed description of the configurations of parts of the material layer forming unit U2. Note however, in descriptions common to the particle image forming units 10a through 10d, the suffixes a through d will be omitted from the reference numerals, and written such as particle image forming unit 10, image bearing member 100, and so forth.

Image Bearing Member

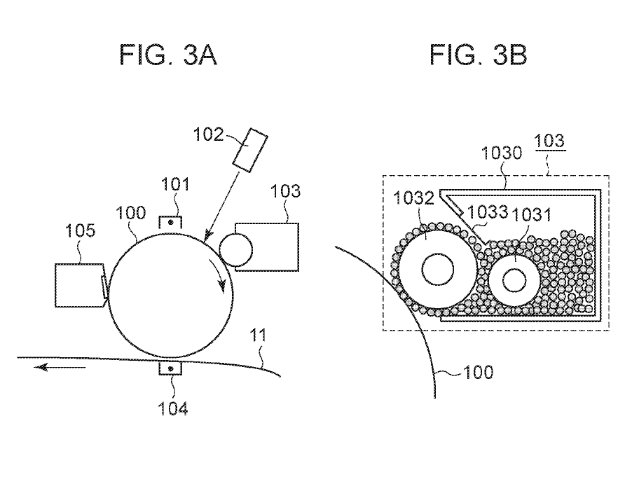

FIG. 3A is a diagram illustrating the configuration of the particle image forming unit 10, and FIG. 3B is a diagram illustrating a detailed configuration of the developing device 103.

The image bearing member 100 is a member for bearing electrostatic latent images. A photosensitive drum, where a photosensitive layer having photoconductivity is formed on the outer perimeter of a cylinder formed of metal such as aluminum or the like, is used here. An organic photoconductor (OPC), amorphous silicon photoconductor, selenium photoconductor, or the like, can be used for the photoconductor. The type of the photoconductor can be selected as appropriate in accordance with the usage of forming apparatus and required performance. The image bearing member 100 is rotatably supported by a frame that is omitted from illustration, and when forming, is rotated at a constant speed in the clockwise direction in the drawing by a motor that is omitted from illustration.

Charging Device

The charging device 101 is charging means for uniformly charging the surface of the image bearing member 100. Although non-contact charging by corona discharge is used in the present embodiment, other charging methods may be used, such as roller charging where a charging roller is brought into contact with the surface of the image bearing member 100.

Exposing Device

The exposing device 102 is exposing means that expose the image bearing member 100 in accordance with image information (slice data), and form an electrostatic latent image on the surface of the image bearing member 100. The exposing device 102 is made up of a light source such as a semiconductor laser, light-emitting diode, or the like, a scanning mechanism made up of a polygon mirror rotating at high speed, and an optical member such as an imaging lens or the like, for example.

Developing Device

The developing device 103 is developing means that visualize electrostatic latent images by supplying developing agent (structural material powder or support material powder here) to the image bearing member 100 (an image visualized by developing agent will be referred to as a particle image in the present specification). The developing device 103 has a structure of a so-called developing cartridge, and preferably is provided detachably mounted to the material layer forming unit U2. The reason is that replacing cartridges enables easy supplying and changing of developing agent (structural material and support material).

Alternatively, an arrangement may be made where the image bearing member 100, developing device 103, cleaning device 105, and so forth are formed as an integrated cartridge (a so-called process cartridge), with the image bearing member itself being replaced. A process cartridge configuration excels in practicality and convenience in a case where the image bearing member 100 is worn or deteriorated due to the type, hardness, and grain size of the structural material or support material, and replacement is necessary.

Transfer Device

A transfer device 104 is transfer means for transferring particle images on the image bearing member 100 onto the surface of the first conveyance member 11. The transfer device 104 is disposed on the opposite side of the first conveyance member 11 from the image bearing member 100, and electrostatically transfers the particle image to the first conveyance member 11 side by applying voltage of opposite polarity to the particle image on the image bearing member 100. Transfer from the image bearing member 100 to the first conveyance member 11 is also referred to as primary transfer. Although transfer using corona discharge is used in the present embodiment, roller transfer, or transfer methods other than electrostatic transfer, may be used.

Cleaning Device

The cleaning device 105 is means that recover developing agent particles remaining untransferred on the image bearing member 100, and clean the surface of the image bearing member 100. Although a blade-type cleaning device 105 where a cleaning blade in contact with the image bearing member 100 in a counter direction scrapes off developing agent particles is employed in the present embodiment, brush or electrostatic adsorption cleaning devices may be used instead.

First Conveyance Member

The first conveyance member (hereinafter referred to as first conveyance belt) 11 is a bearing member onto which particle images formed at each particle image forming unit 10 are transferred. A particle image of structure material is transferred from the first particle image forming unit 10a at the upstream side, following which a particle image of support material is transferred from the second particle image forming unit 10b at the downstream side, thereby forming one material layer on the surface of the first conveyance belt 11.

The first conveyance belt 11 is an endless belt having on the surface thereof a dielectric layer of resin, polyimide, or the like, and is tensioned over multiple rollers 110 and 111, as illustrated in FIG. 1. Note that the first conveyance belt 11 may be a belt where a dielectric material has been coated on the surface of an electroconductive substrate.

Also, a tension roller may be provided besides the rollers 110 and 111, so that the tension of the first conveyance belt 11 can be adjusted. At least one of the rollers 110 and 111 is a driving roller that rotates the first conveyance belt 11 in the counter-clockwise direction in FIG. 1 by driving force of an unshown motor when forming images. The roller 110 is a roller that forms a secondary transfer portion with a secondary transfer roller 31 of the layering unit U3.

Belt Cleaning Device

The belt cleaning device 12 is means that clean material adhering to the surface of the first conveyance belt 11. Although a blade-type cleaning device where a cleaning blade in contact with the first conveyance belt 11 in a counter direction scrapes off material is employed in the present embodiment, brush or electrostatic adsorption cleaning devices may be used instead.

Material Layer Detection Sensor

The material layer detection sensor 13 is detecting means that read the material layer borne on the surface of the first conveyance belt 11. The detection results of the material layer detection sensor 13 are used for positioning of the material layer, timing control of the downstream layering unit U3, detection of abnormality in the material layer (not desired shape, no material layer, great variation in thickness, great positional deviation of material layer, etc.) and so forth.

Layering Unit

The configuration of the layering unit U3 will be described next. The layering unit U3 is a unit that forms a three-dimensional object by receiving material layers formed by the material layer forming unit U2 from the first conveyance belt 11 and sequentially layering these. The layering unit U3 may also form a three-dimensional object by receiving material layers from outside of the apparatus 1 and sequentially layering these.

The layering unit U3 includes, as illustrated in FIG. 1, the conveying member (also referred to as “second conveyance member”) 30, the secondary transfer roller 31, a material layer detecting sensor 32, the temperature adjusting unit 33, and the stage 34. The configuration of the parts of the layering unit U3 will be described in detail below.

Second Conveyance Member (Conveyance Belt)

The second conveyance member 30 receives material layers formed at the material layer forming unit U2, or receives material layers supplied from outside of the apparatus 1, and supports and conveys the material layers to a layering position facing a forming face of the stage 34. Note that the layering position is a position where layering of material layers (layering on the upper face of the stage 34 or on a partly formed three-dimensional object 37 that is being formed on the stage 34) is performed. The layering position in the configuration in FIG. 1 is a portion where the second conveyance member 30 is nipped between the temperature adjusting unit 33 and the stage 34.

The shape of the second conveyance member 30 is not restricted in particular, and any shape may be employed as long as received material layers can be supported on the surface of the second conveyance member 30 and the materials layers can be conveyed by the second conveyance member 30 traveling or rotating. The shape of the second conveyance member 30 may be an endless belt, a continuous track where multiple plate-shaped members are linked (crawler), or a plate-shaped member configured so as to be movable. Although the second conveyance member 30 will be described as being an endless belt member in the present embodiment, the present invention is not restricted to this arrangement.

In the present embodiment, the second conveyance member 30 (hereinafter, referred to simply as “belt 30”) is an endless belt made of material such as resin, polyimide, metal, or the like, and is tensioned around the secondary transfer roller 31, and multiple rollers 301, 302, 303, and 304, as illustrated in FIG. 1. The belt 30 may be a belt formed of a substrate that is coated with a material different from the material of the substrate.

At least one of the secondary transfer roller 31 and the rollers 301 and 302 is a driving roller that causes the belt 30 to rotate in the clockwise direction in FIG. 1 under driving force of a motor that is omitted from illustration. That is to say, the belt 30 is a rotatable endless belt. The rollers 303 and 304 are a roller pair serving to adjust tension of the belt 30 and to maintain the belt 30 passing the layering position (e.g., the material layer conveyed to the layering position) in a flat state. The belt 30 receives the material layer as described above, and supports the received material layer on the surface of the belt 30.

Now, the face of the belt 30 that supports the material layer at the layering position will be referred to as a supporting face S. The supports face S is a flat surface having a finite region, and the size and shape of this region are the size and shape of a flat surface region of the belt 30 generally parallel to the stage 34. The portion of the belt 30 from the part in contact with the roller 303 to the part in contact with the roller 304 is parallel to the stage 34, and accordingly this portion is the supports face S. The region that can actually support the material layer at the layering position is a partial region of the supporting face S. This region will be referred to as a largest forming region A. The largest forming region A is decided by the size of the stage 34 and so forth, and typically is a rectangular region.

Secondary Transfer Roller

The secondary transfer roller 31 is transfer means of transferring the material layer from the first conveyance belt 11 of the material layer forming unit U2 to the belt 30 of the layering unit U3. The secondary transfer roller 31 may transfer material layers from outside of the apparatus 1 onto the belt 30 of the layering unit U3. The secondary transfer roller 31 nips the first conveyance belt 11 and the belt 30 between itself and the roller 110 of the material layer forming unit U2 serving as an opposing roller, thereby forming a secondary transfer nip between the two belts. Bias of opposite polarity of the material layer is applied to the secondary transfer roller 31 from a power source omitted from illustration, thereby transferring the material layer to the belt 30 side.

Note that the way in which the material layer is handed from the material layer forming unit U2 to the layering unit U3 is not restricted in particular. A method other than the above-described electrostatic transfer may be used.

Material Layer Detecting Sensor

The material layer detecting sensor 32 is detecting means that read material layers borne on the surface of the belt 30. The detection results of the material layer detecting sensor 32 are used for positioning of the material layers, conveyance control timing to the laying position, and so forth.

Temperature Adjusting Unit

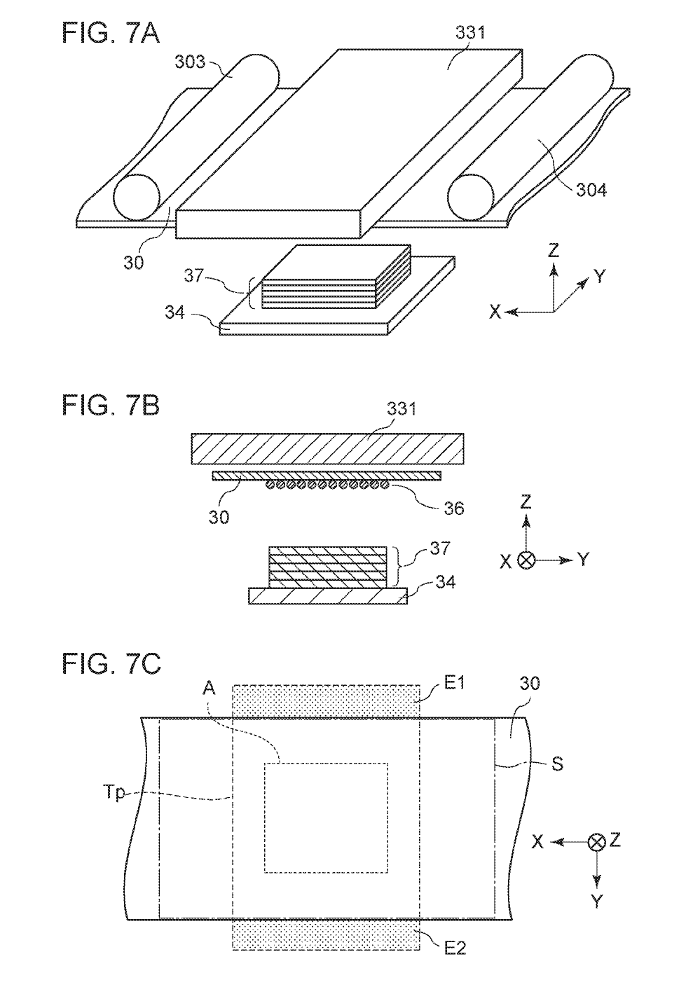

The temperature adjusting unit 33 is a part that adjusts the temperature of the material layer supported by the belt 30. The temperature adjusting unit 33 has a heating member 331 (see FIGS. 7A and 7B). The heating member 331 heats the material layer borne by the belt 30.

In the present embodiment, the heating member 331 heats the material layer after the material layer has been conveyed to the layering position. When the material layer is conveyed to the layering position, the apparatus 1 drives the stage 34 by the stage driving means 35, and pressurizes the members nipped between the stage 34 and the heating member 331, which will be described in detail later. The inner circumferential face of the belt 30 and the heating member 331, and the material layer on the outer circumferential face of the belt 30 and the upper face of the stage 34 or the three-dimensional object 37 on the stage 34 that is partly formed, come into contact. The material layer is pressurized and heated by the heating member 331. Accordingly, heat and pressure are applied to the material layer, and the material layer is fused with the upper face of the stage 34 or the partly-formed three-dimensional object 37 on the stage 34.

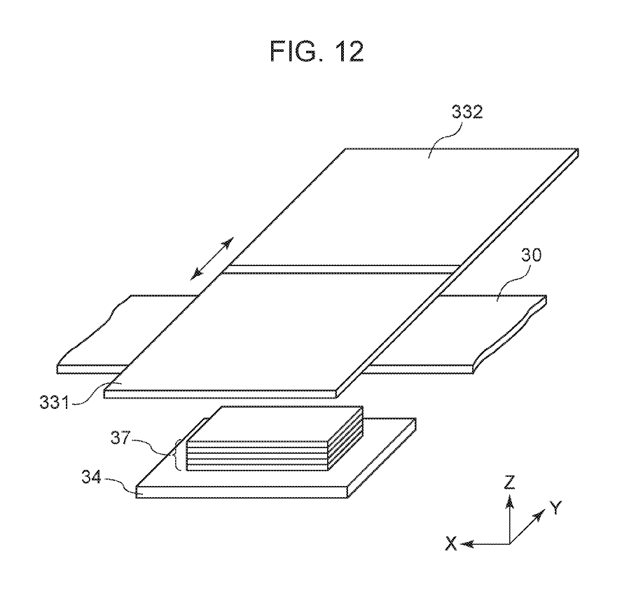

Thereafter, the temperature adjusting unit 33 stops heating of the material layer, and the material layer solidifies by lowering temperature of the material layer by dissipation of heat or active cooling. As a result, the material layer can be fixed on the upper face of the stage 34 or the partly-formed three-dimensional object 37 on the stage 34. Note that the temperature adjusting unit 33 may have a cooling member 332 that actively cools the material layer, besides the heating member 331 (see FIG. 12).

The heating member 331 that the temperature adjusting unit 33 has is not restricted in particular, as long as heating means that can generally uniformly heat within the contact face by being in contact. The heating member 331 may be an arrangement where a plate-shaped member with high thermal conductivity, and a heater that heats this plate-shaped member, are combined, for example. In this case, the heater used to heat the plate-shaped member may be a common industrial heater. For example, infrared heaters such as sheath heaters, ceramic heaters, halogen heaters and so forth, or the like, may be used.

A thermal roller combining a roller formed of a material having high thermal conductivity, and a heater for heating this roller, may be used as the heating member 331. In this case, the heater may be disposed within the roller, for example, to heat the roller from inside. Alternatively, a thermal belt where a belt formed of a material having high thermal conductivity, and a heater for heating this belt, are combined, may be used.

The cooling member 332 provided in the temperature adjusting unit 33 is not restricted in particular, as long as cooling means that can generally uniformly cool within the contact face by coming into contact. The cooling member 332 may be an arrangement where a plate-shaped member with high thermal conductivity, and a cooling device that cools this plate-shaped member, are combined, for example. In this case, the cooling device used to cool the plate-shaped member may be a common industrial cooling device. For example, a chiller or the like may be used.

A cooling roller combining a roller formed of a material having high thermal conductivity, and a cooling device for cooling this roller, may be used as the cooling member 332. In this case, the cooling device may be disposed within the roller, for example, to cool the roller from inside. Alternatively, a cooling belt where a belt formed of a material having high thermal conductivity, and a cooling device for cooling this belt, are combined, may be used.

The temperature adjusting unit 33 is disposed at a position facing the stage 34 across the belt 30, as described above. The lower face (face facing the belt 30) of the heating member 331 of the temperature adjusting unit 33 is a flat surface. The heating member 331 is capable of contact with and separation from the belt 30 by driving means omitted from illustration. The heating member 331 preferably is separated from the belt 30 when the belt 30 is turning, and comes into contact with the belt 30 when the material layer is conveyed to the layering position and the belt 30 stops turning. Accordingly, wear of the belt 30 can be prevented, and smooth transfer of heat can be performed.

Stage

The stage 34 is a planar table having a forming face where multiple material layers are sequentially layered and a three-dimensional object is formed. The forming face of the stage 34 and the supporting face S of the belt 30 are parallel in the present embodiment.

The stage 34 is capable of moving in the vertical direction (direction perpendicular to the forming face) by an actuator (stage driving means 35). The apparatus 1 transfers the material layer from the belt 30 side to the stage 34 side by nipping the material layer supported and conveyed to the layering position between the temperature adjusting unit 33 and stage 34, and applying pressure and heat (and thermal discharge or cooling as necessary). The first layer of the material layer is directly transferred onto the forming face of the stage 34, and the second layer of material layer and thereof are layered upon the three-dimensional object 37 partly formed on the stage 34.

Note that an arrangement may be made where a separate plate-shaped member such as a forming plate is disposed on the stage 34, and the three-dimensional object is formed thereupon. In such a case, the stage 34 and forming plate are collectively deemed to be the “stage” in the present specification. Thus, the temperature adjusting unit 33 and stage 34 make up layering means for layering material layers in the present embodiment.

Operations of Forming Apparatus

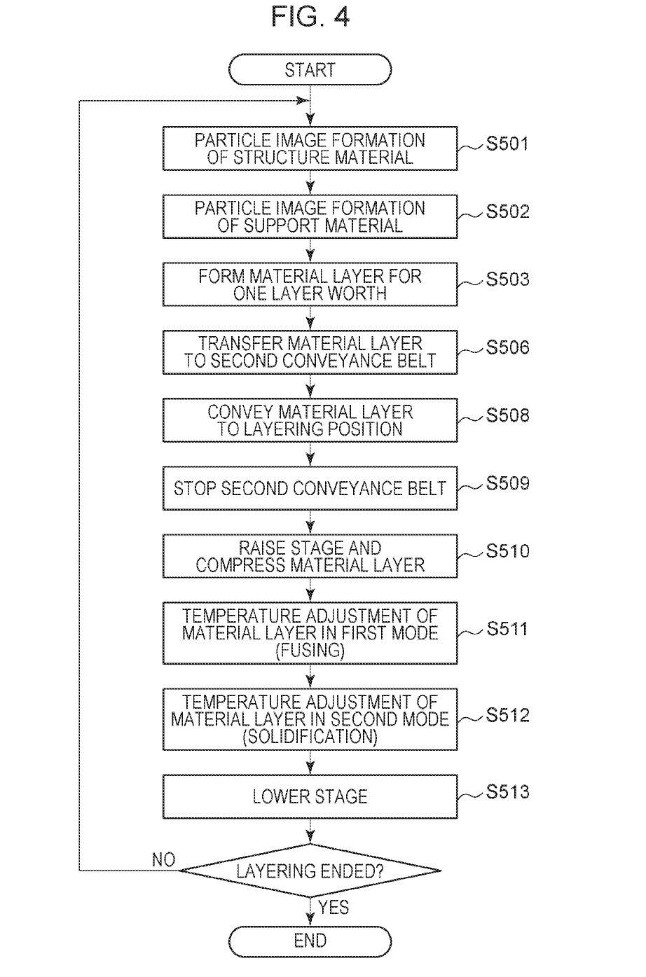

Next, the operations of the forming apparatus having the above-described configuration will be described. Description will be made here in the order of a process of forming the material layers, and a process of layering the material layers, assuming that the slice data generating processing by the control unit U1 has already been completed. FIG. 4 is a flowchart illustrating the operation sequence of the forming apparatus according to the present embodiment.

Material Layer Forming Process

First, the control unit U1 controls drive sources such as motors and so forth, so that the image bearing member 100, first conveyance belt 11, and belt 30, of each particle image forming unit 10 rotate synchronously at the same circumferential speed (process speed). After the rotational speed has stabilized, particle image formation of the particle image forming unit 10a that is furthest upstream is started (S501). That is to say, the control unit U1 controls the charging device 101a to generally uniformly charge the entire region of the surface of the image bearing member 100a at a predetermined polarity and a predetermined charging potential.

Next, the control unit U1 exposes the surface of the charged image bearing member 100a by the exposing device 102a. A potential difference between exposed portions and non-exposed portions is formed here by removing charge by exposing. The image formed by this potential difference is an electrostatic latent image.

On the other hand, the control unit U1 drives the developing device 103a to cause particles of the structure material to adhere to the latent image on the image bearing member 100a, thereby forming a particle image of the structure material. This particle image is subjected to primary transfer onto the first conveyance belt 11 by the transfer device 104a.

The control unit U1 also starts particle image formation at the particle image forming unit 10b at the downstream side, with a predetermined time lag from starting the particle image forming at the particle image forming unit 10a (S502). Formation of the particle image at the particle image forming unit 10b is performed following the same procedures as the formation of the particle image at the particle image forming unit 10a.

A value obtained by dividing the distance from the primary transfer nip at the upstream-side particle image forming unit 10a to the primary transfer nip at the downstream-side particle image forming unit 10b by the process speed is set as the time lag in starting particle image formation. Accordingly, the two particle images formed at the particle image forming units 10a and 10b are disposed positioned on the first conveyance belt 11, and one layer worth of a material layer made up of structural material and support material is formed (S503). Note that in a case where the cross-section has not overhang portions and does not need support portions, formation of the particle image by the particle image forming unit 10b is not performed, and in this case, the material layer is formed by the particle image of the structural material alone. Thereafter, the material layer is conveyed to the layering unit U3 by the first conveyance belt 11.

Layering Process

While material layer forming operations are being performed as described above, the belt 30 of the layering unit U3 is synchronously rotated in contact with the first conveyance belt 11, at the same circumferential speed (process speed). At the timing of the leading edge of the material layer on the first conveyance belt 11 reaching the secondary transfer nip, the control unit U1 applies predetermined transfer bias to the secondary transfer roller 31, and transfers the material layer onto the belt 30 (second conveyance belt) (S506).

The belt 30 continues turning at the same process speed and conveys the material layer in the direction of the arrow in FIG. 1. Upon the position of the material layer on the belt being detected by the material layer detecting sensor 32, the control unit U1 conveys the material layer to the predetermined layering position based on the detection results thereof (S508). The control unit U1 stops the belt 30 at the timing of the material layer reaching the layering position, and the material layer is positioned at the layering position (S509). Thereafter, the control unit U1 raises the stage 34 (to come close to the face of the belt), and brings the upper face of the stage 34 (in a case of first layer) or the partly-formed three-dimensional object 37 on the stage 34 (in a case of second layer or thereafter) into contact with the material layer on the belt 30. The three-dimensional object and the material layer are pressurized by being nipped between the stage 34 and the heating member 331 of the temperature adjusting unit 33 (S510).

In this state, the control unit U1 controls the temperature of the temperature adjusting unit 33 in accordance with a predetermined temperature control sequence. Specifically, a first mode where the heating member 331 is heated to a first target temperature is first performed for a predetermined amount of time, thereby thermally melting the particle material of the material layer (S511). That is to say, in the first mode, the material layer is heated by the heating member 331. Thus, the material layer is softened, and the sheet-like material layer and the upper face of the stage 34 or the partly-formed three-dimensional object 37 on the stage 34 adhere. Thereafter, a second mode of adjusting the temperature of the temperature adjusting unit 33 to a second target temperature lower than the first target temperature that is the target temperature in the first mode is performed for a predetermined amount of time, and the softened material layer is solidified (S512).

Now, the temperature control sequence, target temperatures, heating times, and so forth, are set in accordance with the properties of the structural material and support material used in the material layer formation. For example, the first target temperature in the first mode is set to a value higher than the highest temperature of the melting point or glass transition point of the materials used for forming the material layer.

On the other hand, the second target temperature in the second mode is set to a value lower than the crystallization temperature, or glass transition point for amorphous materials, of the materials used for forming the material layer. Performing such temperature control enables the entirety of a material layer where multiple types of particle materials having different thermal melting properties coexist to be thermo-plasticized (softened) in a common melting temperature region, and thereafter the entire material layer to be solidified in a common solidifying temptation region. Accordingly, melting and solidification of the material layer where multiple types of particle materials coexist can be performed in a stable manner.

Note that in the first mode and the second mode, if the control range of temperature is too broad, it will take time to stabilize temperature control, and the layering process will take time excessively. Accordingly, the lower limit temperature of the control range of the first target temperature preferably is the highest temperature of the melting point or glass transition point of the materials used for forming the material layer, with the upper limit temperature being around +50° C. of the lower limit temperature. Similarly, the upper limit temperature of the control range of the second target temperature preferably is the lowest temperature of the crystallization temperature, or glass transition point for amorphous materials, of the materials used for forming the material layer, with the lower limit temperature being around −50° C. of the upper limit temperature.

For example, in a case of using a material of which the primary component is ABS (glass transition point of 130° C.) as the structural material and material of which the primary component is maltotetraose (glass transition point of 156° C.) as the support material, the following settings are suitable. That is to say, setting the control range of the first target temperature to 150° C. or higher and 190° C. or lower, and the control range of the second target temperature to 90° C. or higher and 130° C. or lower is suitable.

After ending the second mode, the control unit U1 lowers the stage 34 (S513). Note that in a case where thermal dissipation or cooling is to be performed by distancing the heating member 331 from the belt 30 in the above-described second mode, this step may be omitted.

Once the entire material layer is peeled loose from the surface of the belt 30 and layering of the material layer is completed, execution of the next material layer forming processing is started (S501 and thereafter). A desired three-dimensional object is formed on the stage 34 by repeating the above-descried material layer forming process and layering process as many times as necessary.

Although a case of performing the layering process and material layer forming process in an alternating manner has been described here, formation throughput can be improved by performing the material layer forming processing to form the material layer to be layered next, in parallel, while performing the layering process.

Finally, the three-dimensional object is removed from the stage 34, and portions formed with the support material (support portions) are removed, thereby manufacturing the final formed object (product). Now, in a case where a water-soluble material has been used as the support material, the support portions can be removed by bringing the three-dimensional object removed from the stage 34 into contact with a liquid including water, such as water. Also, predetermine processing (e.g., cleaning, assembly, etc.) may be further performed on the three-dimensional object after having removed the support portions, thereby manufacturing the final formed object (product).

Relation Between Heating Member and Conveying Member

The following is a detailed description of the relation between the heating member 331 and the belt 30 (conveyance member), which is a feature of the present invention, made with reference to the drawings. First, the relation between a heating member and conveyance member in a conventional forming apparatus (comparative embodiment) will be described.

### First Comparative Embodiment

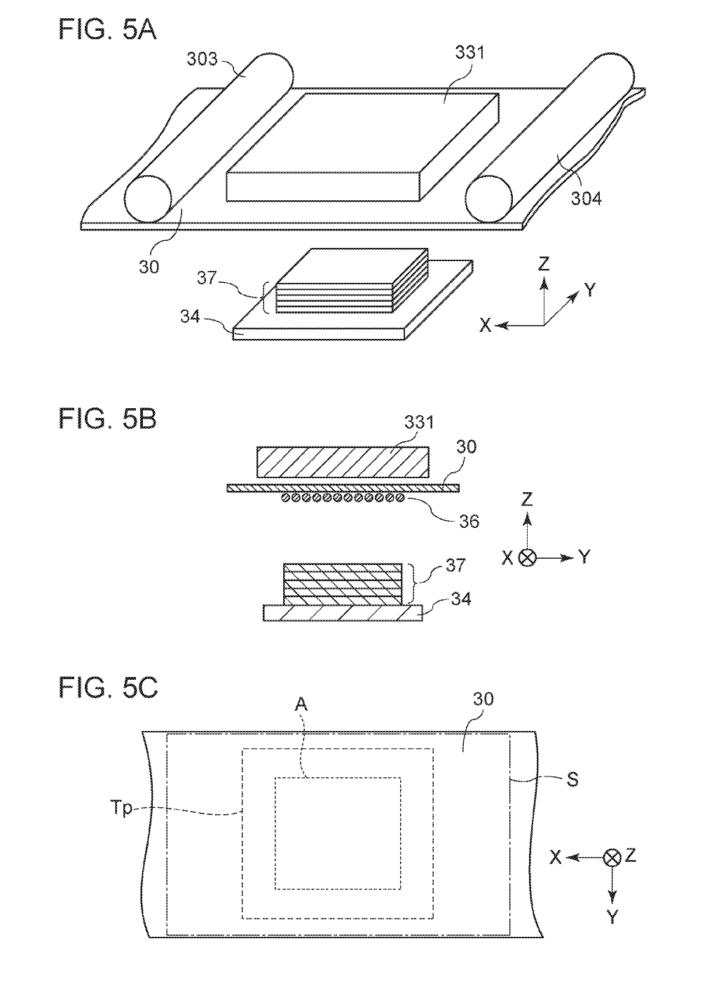

FIGS. 5A through 5C are diagrams schematically illustrating the relation between a heating member and conveyance member at the layering position, in the forming apparatus according to the first comparative embodiment. FIG. 5A is a perspective view, FIG. 5B is a cross-sectional view perpendicular to the X axis in FIG. 5A, and FIG. 5C is a cross-sectional view perpendicular to the Z axis in FIG. 5A and illustrates a face on the conveyance member that comes into contact with the heating member.

The width of the heating member 331 is smaller than the width of the belt 30 in the first comparative embodiment, as illustrated in FIGS. 5A through 5C. The term “width” as used here means the length of the belt width in a direction perpendicular to the conveyance direction of the belt 30.

Tp here represents a projection plane where the heating region of the heating member 331 has been projected perpendicularly on the plane where the supporting face S at which the conveyance member (belt 30) supports the material layer exists, at the layering position. In the first comparative embodiment, the edges of the projection plane Tp exist on the inner side from the edges of the supporting face S, in both the X direction and Y direction that is orthogonal to the X direction, in an XY plane on the supporting face (on the supporting face S). That is to say, the projection plane Tp does not have extending regions that extend further to the outer side from both edges of the supporting face S, on both edges of the projection plane Tp.

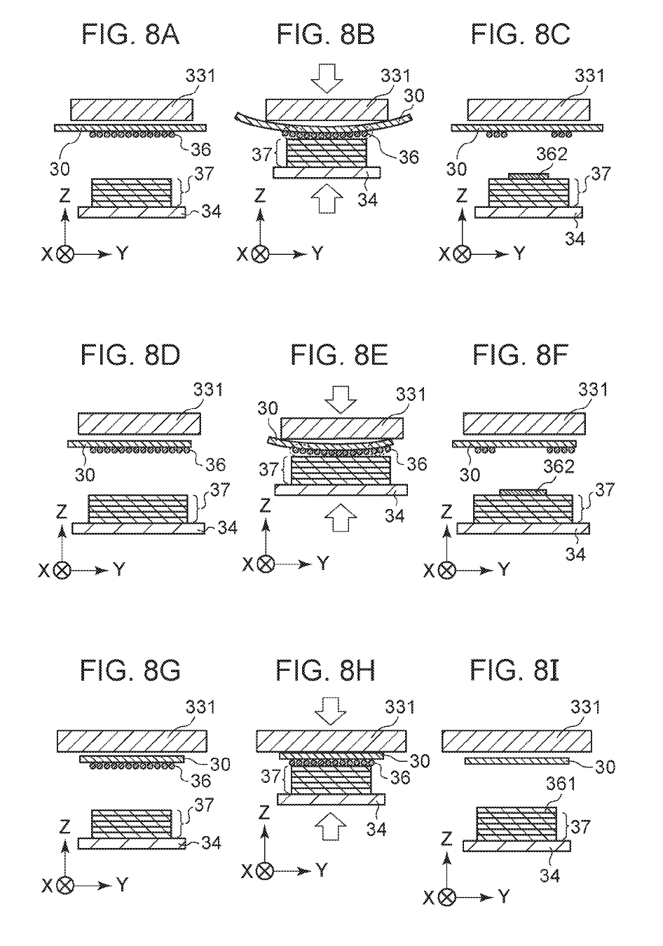

FIGS. 8A through 8C schematically illustrate the layering process in the first comparative embodiment, showing a cross-section as viewed from the conveyance direction of the belt 30. When pressure is applied by the stage driving means 35 to pressurize between the stage 34 and heating member 331, the state transitions from that in FIG. 8A to that in FIG. 8B. That is to say, in a case where the width of the heating member 331 is smaller than the width of the belt 30, part of the belt 30 (typically the edge portion at both sides) does not come into contact with the heating member 331 with regard to the width direction. Consequently, heat from the heating member 331 may not sufficiently reach, or may be dissipated, so the temperature of this portion will be lower than the portion in contact with the heating member 331.

That is to say, in a case where the width of the heating member 331 is smaller than the width of the belt 30, uneven temperature occurs within the plane of the belt 30, and distortion (e.g., warping, undulation, etc.) occurs at the supporting face S of the belt 30. This also results in distortion occurring in the largest forming region A. Consequently, there are portions of a material layer 36 supported by the belt 30 that do not come into contact with the upper face of the partly-formed three-dimensional object 37 being formed on the stage 34, as illustrated in FIG. 8B. Even if the material layer 36 is attempted to be melted and fixed at the upper face of the partly-formed three-dimensional object 37, the portions that are not in contact with the upper face of the partly-formed three-dimensional object 37 cannot be fixed to this upper face. When the belt 30 and stage 34 are subsequently pulled apart, the portions of the material layer 36 that were not in contact with the upper face of the partly-formed three-dimensional object 37 remain on the surface of the belt 30, resulting in defective layering (FIG. 8C). Note that increasing the pressure by the stage driving means 35 to smooth out the distortion of the supporting face S is undesirable, since the three-dimensional object will be deformed. Second Comparative Embodiment

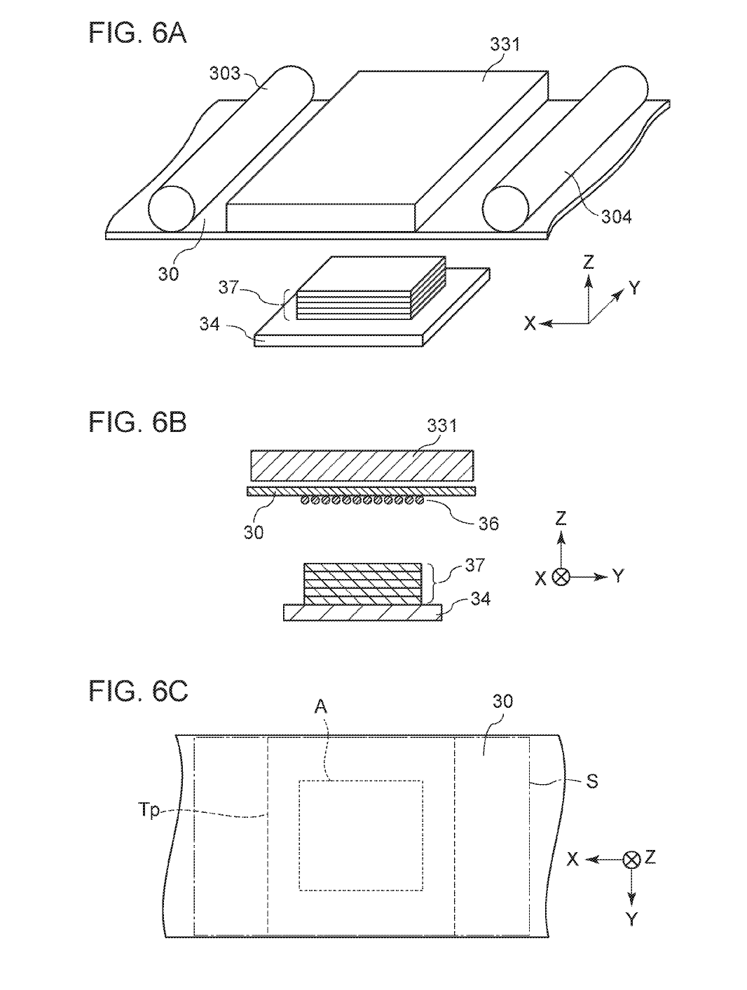

FIGS. 6A through 6C are diagrams schematically illustrating the relation between a heating member and conveyance member at the layering position, in the forming apparatus according to the second comparative embodiment. FIG. 6A is a perspective view, FIG. 6B is a cross-sectional view perpendicular to the X axis in FIG. 6A, and FIG. 6C is a cross-sectional view perpendicular to the Z axis in FIG. 6A and illustrates a face on the conveyance member that comes into contact with the heating member.

The width of the heating member 331 is equal to the width of the belt 30 in the second comparative embodiment, as illustrated in FIGS. 6A through 6C. Tp here represents a projection plane where the heating region of the heating member 331 has been projected perpendicularly on the plane where the supporting face S at which the conveyance member (belt 30) supports the material layer exists, at the layering position. In the second comparative embodiment, the width of the supporting face S and the width of the projection plane Tp agree in the Y axial direction, while the edges of the projection plane Tp exist on the inner side from the edges of the supporting face S in the X direction (FIG. 6C). That is to say, the projection plane Tp does not have extending regions that extend further to the outer side from both edges of the supporting face S, on both edges of the projection plane Tp.

In a case of using a combination of the plate-shaped member with high thermal conductivity and a heater that heats the plate-shaped member, as the heating member 331 as described above, the edge portions of the plate-shaped member have a large area coming into contact with the ambient atmosphere as compared to the middle portion. Accordingly, the edge portions readily dissipate heat as compared to the middle portion and as a result, the temperature at the edge portions becomes lower than at the middle portion. Thus, uneven temperature actually occurs within the heating region of the heating member 331. The same thing will occur with other planar heaters as well.

Bringing the heating member 331 that has such uneven temperatures within the heating region into contact with the belt 30 and heating the belt 30 will result in uneven temperatures within the plane of the belt 30 as well. This leads to distortion in the supporting face S of the belt 30 in the same way as in the first comparative embodiment, and defective layering results. Even if no unevenness in temperature occurred within the heating region of the heating member 331, there is a high probability that detective layering will occur as described below in a case where the width of the heating member 331 is equal to the width of the belt 30.

FIGS. 8D through 8F schematically illustrate the layering process in the second comparative embodiment, showing a cross-section as viewed from the conveyance direction of the belt 30. As described above, the material layer 36 is transferred by the material layer forming unit U2 onto the belt 30, and the transferred material layer 36 is conveyed to the layering position, supported by the belt 30. At this time, there may actually be positional deviation at the time of transfer from the material layer forming unit U2 or wandering of the belt 30, resulting in deviation in relative positional relation between the belt 30 and the heating member 331 (FIG. 8D).

When pressure is applied between the stage 34 and heating member 331 by the stage driving means 35, the state transitions to that in FIG. 8E. That is to say, part of the belt 30 (typically one edge portion) does not come into contact with the heating member 331 with regard to the width direction. Consequently, uneven temperature occurs within the supporting face S of the belt 30, distortion occurs in the supporting face S of the belt 30, and as a result, defective layering occurs (FIG. 8F), in the same way as in the first comparative embodiment.

### First Embodiment

FIGS. 7A through 7C are diagrams schematically illustrating the relation between a heating member and conveyance member at the layering position, in the apparatus 1 according to a first embodiment. FIG. 7A is a perspective view, FIG. 7B is a cross-sectional view perpendicular to the X axis in FIG. 7A, and FIG. 7C is a cross-sectional view perpendicular to the Z axis in FIG. 7A and illustrates a face on the conveyance member that comes into contact with the heating member.

The width of the heating member 331 is greater than the width of the belt 30 in the first embodiment, as illustrated in FIGS. 7A through 7C. Further, both end portions of the heating member 331 in the width direction are disposed so as to extend past the both end portions of the belt 30 in the width direction.

Tp here represents a projection plane where the heating region of the heating member 331 has been projected perpendicularly on the plane where the supporting face S at which the conveyance member (belt 30) supports the material layer exists, at the layering position. In the first embodiment, the edges of the projection plane Tp exist on the outer side from the edges of the supporting face S in the Y direction (FIG. 7C). That is to say, the projection plane Tp has extending regions E1 and E2 that extend further to the outer side from both edges of the supporting face S.

FIGS. 8G through 8I schematically illustrate the layering process in the first embodiment, showing a cross-section as viewed from the conveyance direction of the belt 30. The temperature at the edge portions of the heating member 331 tends to be lower as compared to the middle portion due to thermal dissipation, as described above. However, the heating member 331 in the present embodiment is configured so that the edge portions extend beyond the supporting face S when projected perpendicularly with regard to the width direction of the belt 30. Accordingly, uneven temperature in the width direction of the supporting face S of the belt 30 when bringing the heating member 331 into contact with the belt 30 can be reduced as compared to the first comparative embodiment and the second comparative embodiment. As a result, distortion of the supporting face S of the belt 30 can be suppressed (FIG. 8H), and occurrence of defective layer can be suppressed (FIG. 8I).

It is sufficient for the width of the heating region of the heating member 331 to be greater than the width of the belt 30. Alternatively, the width of the heating region of the heating member 331 may be decided taking into consideration the width of wandering of the belt 30. Although this depends on the type of the heating member 331, the width of the heating region of the heating member 331 preferably is 1.05 times or more the width of the belt 30, even more preferably is 1.1 times or more the width of the belt 30, and particularly preferably is 1.3 times or more the width of the belt 30. That is to say, the length of the projection plane Tp of the heating region of the heating member 331 following a line connecting the two extending regions E1 and E2 is preferably 1.05 times or more the length of the supporting face S along this straight line.

Although the upper limit for the width of the heating region of the heating member 331 is not restricted in particular, this preferably is three times or less the width of the belt 30, and more preferably two times or less, from the perspective of suppressing electric power consumption and forming apparatus size. For example, in a case of using a 70-mm wide endless belt as the belt 30, an arrangement where three 590-W sheath heaters are embedded in a stainless-steel plate 120 mm in the belt width direction, 120 mm in the belt conveyance direction, and 20 mm thick, can be used as the heating member 331. The width of the heating region of the heating member 331 is approximately 171% of the width of the belt 30 in this case. A cuboid three-dimensional object, 30 mm in the belt width direction, 30 mm in the belt conveyance direction, and 2 mm high, was formed by layering forming, using this forming apparatus. Stable layering was performed without occurrence of layering defects.

Also, in a case of using a 208-mm wide endless belt as the belt 30, an arrangement where five 550-W sheath heaters are embedded in a stainless-steel plate 230 mm in the belt width direction, 120 mm in the belt conveyance direction, and 16 mm thick, can be used as the heating member 331. The width of the heating region of the heating member 331 is approximately 111% of the width of the belt 30 in this case. A cuboid three-dimensional object, 120 mm in the belt width direction, 100 mm in the belt conveyance direction, and 30 mm high, was formed by layering forming, using this forming apparatus. Stable layering was performed without occurrence of layering defects.

Further, using a 150-mm wide endless belt as the belt 30, an arrangement where three 590-W sheath heaters are embedded in a stainless-steel plate 120 mm in the belt width direction, 120 mm in the belt conveyance direction, and 20 mm thick, was used as the heating member 331. Using this forming apparatus, a cuboid three-dimensional object, 30 mm in the belt width direction, 30 mm in the belt conveyance direction, and 2 mm high, was formed by layering forming, but layering defects occurred partway through forming, and forming was not successful. It is thought that this is due to the material layer supported on the supporting face S of the belt 30 and the upper face of the partly-formed three-dimensional object 37 formed on the stage 34 not coming into contact, because the belt 30 greatly warped in the width direction.

Further, with Ts representing a projection plane where the stage 34 has been projected perpendicularly on the plane where the supporting face S at which the conveyance member (belt 30) supports the material layer exists, at the layering position, the projection plane Ts preferably does not have extending regions extending to the outer side from both edges of the supporting face S. That is to say, preferably, the stage 34 is hidden by the conveyance member as viewed from the heating member 331 side, and the stage 34 has no regions opposing the extending regions of the heating region at the layering position. If the stage 34 extends beyond the belt 30, the extending regions are directly heated by the extending regions E1 and E2. This heat may result in heating conditions of portions of the formed object on the stage 34 near the edges of the conveyance member differing from other portions, which may affect the shape of the formed object. This is thought to have a particularly great impact at the initial stages of layering.

The relation between the width of the heating member 331 and the width of the belt 30 in the apparatus 1 according to the present embodiment is as described above. Accordingly, the manufacturing method of a three-dimensional object by the apparatus 1 includes
(1) a conveyance process of supporting a material layer on a conveyance member and conveying,
(2) a heating process of heating the material layer supported on the conveyance member, and
(3) sequentially layering material layers onto a stage.

The heating process (2) is a process of heating a broader area than the supporting face, with regard to at least one direction of the supporting face where the conveyance member supports the material layer. Thus, occurrence of the above-described distortion of the conveyance member in the X direction or Y direction can be suppressed, and occurrence of layering defects can be suppressed. Note that the heating process (2) may be performed at the same time as the layering process (3) as described above or after the layering process (3), or may be performed before the layering process (3).

### Second Embodiment

A forming apparatus where the conveyance member of the layering unit U3 is an endless-belt-shaped member (belt 30) has been described, but the conveyance member of the layering unit U3 is not restricted to this. A forming apparatus 2 according to a second embodiment of the present invention will be described below.

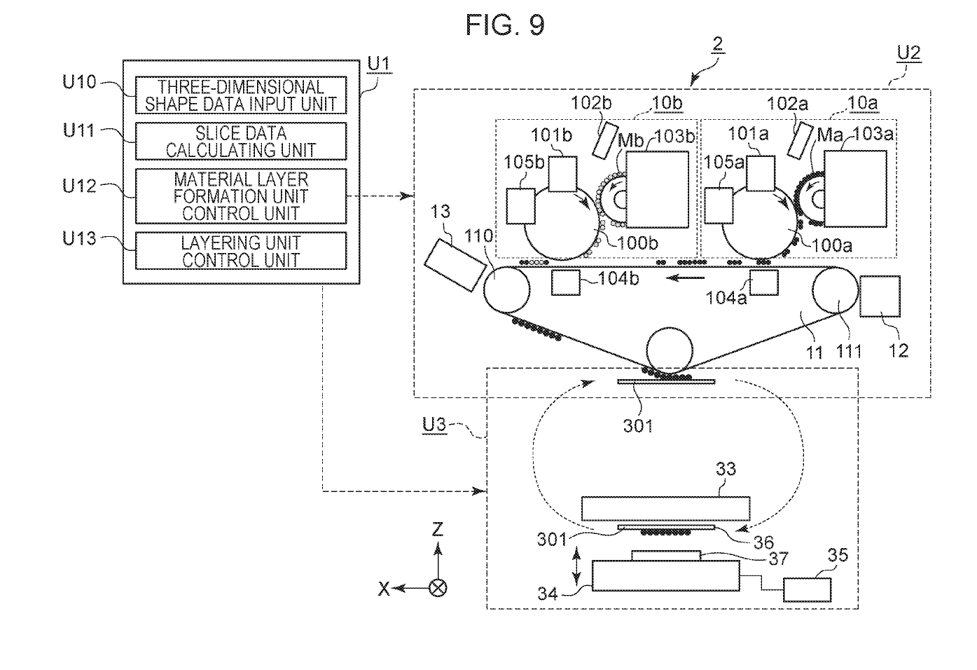

FIG. 9 is a diagram schematically illustrating the configuration of a forming apparatus 2 (hereinafter referred to as “apparatus 2”) according to the second embodiment. The configuration of the apparatus 2 is the same as that of the apparatus 1 other than the layering unit U3, so description of portions other than the layering unit U3 will be omitted.

Layering Unit

The layering unit U3 is a unit that receives material layers formed at the material layer forming unit U2 from the first conveyance belt 11, which are sequentially layered, thereby forming a three-dimensional object. The layering unit U3 includes a conveyance plate (conveyance member) 301, the temperature adjusting unit 33, and the stage 34, as illustrated in FIG. 9. The configuration of the parts of the layering unit U3 that differ from the first embodiment will be described in detail below.

Conveyance Plate (Conveyance Member)

The conveyance plate 301 receives material layers formed at the material layer forming unit U2 or material layers externally supplied to the apparatus 2, and supports and conveys the material layers to the layering position. Note that the layering position is a position where layering of material layers (layering on the upper face of the stage 34 or on a partly-formed three-dimensional object 37 that is being formed on the stage 34) is performed. The layering position in the configuration in FIG. 9 is a portion where the conveyance plate 301 is nipped between the temperature adjusting unit 33 and the stage 34.

The conveyance plate 301 is a plate-shaped member made of a material such as resin, polyimide, metal, or the like. The conveyance plate 301 is movable by being conveyed by conveyance plate moving means (omitted from illustration) such as a belt conveyer, for example. After receiving a material layer from the material layer forming unit U2 or from outside of the apparatus 2 at a predetermined position, the conveyance plate 301 is conveyed by the conveyance plate moving means (omitted from illustration), and moves to the layering position. Accordingly, the material layer supported by the conveyance plate 301 is conveyed to the layering position.

Temperature Adjusting Unit

The temperature adjusting unit 33 is a part that adjusts the temperature of the material layer supported on the conveyance plate 301, and has the heating member 331. The heating member 331 heats the material layer supported by the conveyance plate 301. The temperature adjusting unit 33 according to the present embodiment is the same as the temperature adjusting unit 33 according to the first embodiment except for adjusting the temperature of the material layer supported by the conveyance plate 301, instead of the material layer supported by the belt 30.

Relation Between Heating Member and Conveying Member

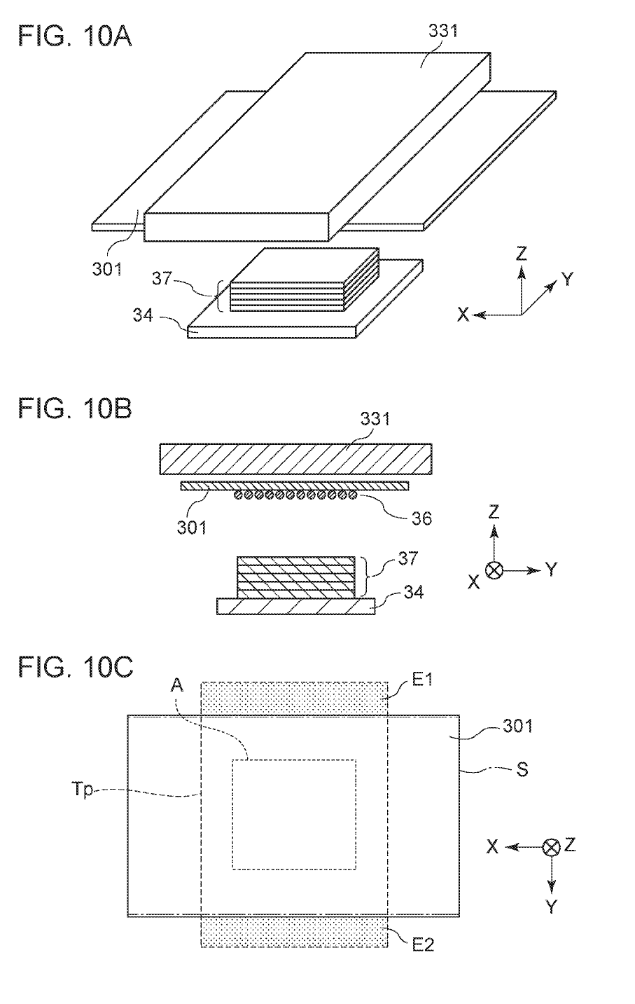

FIGS. 10A through 10C are diagrams schematically illustrating the relation between a heating member and conveyance member at the layering position, in the apparatus 2 according to the second embodiment. FIG. 10A is a perspective view, FIG. 10B is a cross-sectional view perpendicular to the X axis in FIG. 10A, and FIG. 10C is a cross-sectional view perpendicular to the Z axis in FIG. 10A and illustrates a face on the conveyance member that comes into contact with the heating member.

The X axis here agrees with the conveyance direction of the conveyance member. As illustrated in FIGS. 10A through 10C, the width of the heating member 331 is greater than the width of the conveyance plate 301 in the Y axis direction (the direction perpendicular to the conveyance direction in the plane of the conveyance member supporting the material layer) according to the present embodiment.

With regard to the Y axis direction, both end portions of the heating member 331 in the width direction are disposed so as to extend past the both end portions of the conveyance plate 301 in the width direction. Tp here represents a projection plane where the heating region of the heating member 331 has been projected perpendicularly on the plane where the supporting face S at which the conveyance member (conveyance plate 301) supports the material layer exists, at the layering position. In the present embodiment, the edges of the projection plane Tp exist on the outer side from the edges of the supporting face S in the Y direction (FIG. 10C). That is to say, the projection plane Tp has extending regions E1 and E2 that extend further to the outer side from both edges of the supporting face S. Note that in a case of using a plate-shaped member as the conveyance member as in the present embodiment, the entire face of the conveyance member facing the stage 34 is the supporting face S.

Further, with Ts representing a projection plane where the stage 34 has been projected perpendicularly on the plane where the supporting face S at which the conveyance plate 301 supports the material layer exists, at the layering position, the projection plane Ts preferably does not have extending regions extending to the outer side form both edges of the supporting face S. That is to say, preferably, the stage 34 has no regions opposing the extending regions of the heating region at the layering position. If the stage 34 extends beyond the conveyance plate in the Y axis direction, the extending regions are directly heated by the extending regions E1 and E2. This heat may result in heating conditions of portions of the formed object on the stage 34 near the edges in the Y axis direction differing from other portions, which may affect the shape of the formed object. This is thought to have a particularly great impact at the initial stages of layering.

According to this configuration, in the present embodiment the edges of the heating member 331 extend from the supporting face S with regard to the width direction of the conveyance plate 301, which is one direction. Accordingly, uneven temperature in the width direction (the Y axis direction here) of the supporting face S of the conveyance plate 301 can be reduced when the heating member 331 is brought into contact with the conveyance plate 301. As a result, distortion of the supporting face S of the conveyance plate 301 can be suppressed, and occurrence of layering defects can be suppressed.

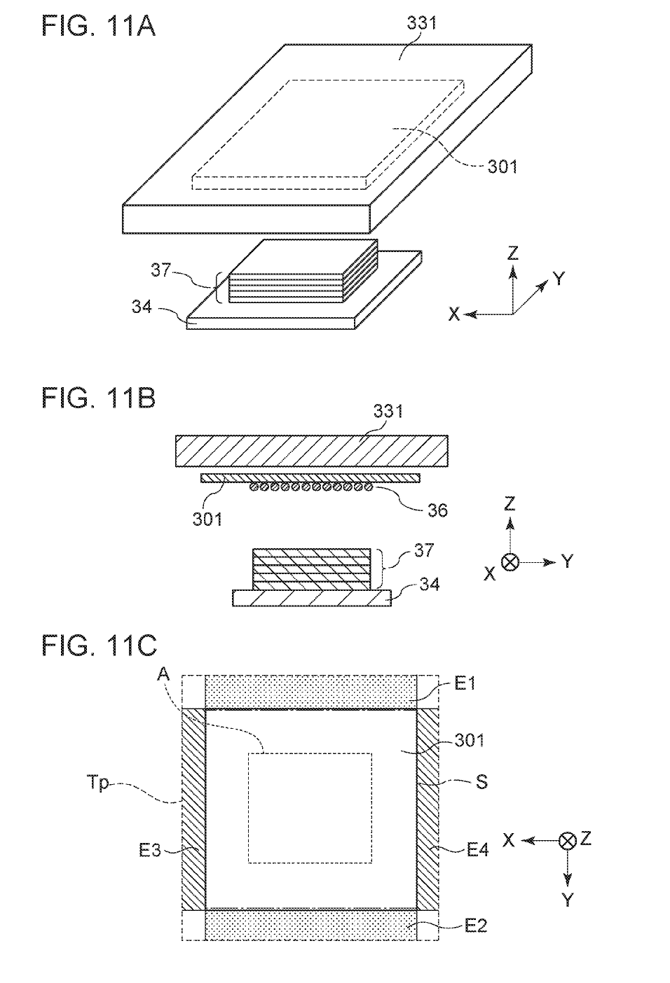

FIGS. 11A through 11C are diagrams schematically illustrating the relation between a heating member and conveyance member at the layering position, in a forming apparatus according to a modification of the second embodiment. FIG. 11A is a perspective view, FIG. 11B is a cross-sectional view perpendicular to the X axis in FIG. 11A, and FIG. 11C is a cross-sectional view perpendicular to the Z axis in FIG. 11A and illustrates a face on the conveyance member that comes into contact with the heating member.

As illustrated in FIGS. 11A through 11C, the width of the heating member 331 is greater than the width of the conveyance plate 301 in both the Y axis direction and X axis direction. Both end portions of the heating member 331 in the width direction are disposed so as to extend past the both end portions of the conveyance plate 301 in the width direction, with regard to both the Y axis direction and X axis direction.

Tp here represents a projection plane where the heating region of the heating member 331 has been projected perpendicularly on the plane where the supporting face S at which the conveyance member (conveyance plate 301) supports the material layer exists, at the layering position. In the present modification, the edges of the projection plane Tp exist on the outer side from the edges of the supporting face S in both the X axis direction and the Y axis direction. That is to say, the projection plane Tp has extending regions E1 and E2 that extend further to the outer side from both edges of the supporting face S, with regard to the Y direction. Further, the projection plane Tp also has extending regions E3 and E4 that extend further to the outer side from both edges of the supporting face S, at both edges of the projection plane Tp, with regard to the X direction perpendicular to the Y direction.

Thus, the present embodiment is configured so that the edges for the heating member 331 extend beyond the supporting face S regarding all width directions of the conveyance plate 301. Accordingly, uneven temperature in the all width directions of the supporting face S of the conveyance plate 301 can be reduced when the heating member 331 is brought into contact with the conveyance plate 301. As a result, distortion of the supporting face S of the conveyance plate 301 can be suppressed, and occurrence of layering defects can be suppressed.

Further, with Ts representing a projection plane where the stage 34 has been projected perpendicularly on the plane where the supporting face S at which the conveyance plate 301 supports the material layer exists, at the layering position, the projection plane Ts preferably does not have extending regions extending to the outer side from both edges of the supporting face S, in the X axis and Y axis directions. That is to say, preferably, the stage 34 is hidden by the conveyance plate 301 as viewed from the heating member 331 side, and the stage 34 has no regions opposing the extending regions of the heating region at the layering position. If the stage 34 extends beyond the conveyance plate in the Y axis direction, the extending portions are directly heated by the extending regions E1 through E4 of the heating member 331. This heat may result in heating conditions of the edge portions of the formed object on the stage 34 near the edges of the conveyance member differing from other portions, which may affect the shape of the formed object. This is thought to have a particularly great impact at the initial stages of layering.

### Third Embodiment

Next, a forming apparatus 3 according to a third embodiment of the present invention will be described. The forming apparatus 3 according to the present embodiment is the same as the configuration of the apparatus 1 according to the first embodiment except for the temperature adjusting unit 33 of the layering unit U3 having a cooling member 332, in addition to the heating member 331.

FIG. 12 is a diagram schematically illustrating the relationship between a heating member, cooling member, and conveyance member, at a layering position, in the forming apparatus 3 according to a modification of a third embodiment.

Tp1 here represents a projection plane where the heating region of the heating member 331 has been projected perpendicularly on the plane where the supporting face S at which the conveyance member (conveyance plate 301) supports the material layer exists, at the layering position. The projection plane Tp1 has extending regions that extend to and exist at the outer side from both edges of the supporting face S, on both edge of the projection plane Tp1. Accordingly, distortion of the supporting face S of the conveyance member can be suppressed when heating the material layer supported on the conveyance member by the heating member 331.

Further, in a case where the temperature adjusting unit 33 has a cooling member 332 that cools the material layer supported on the conveyance member, as in the present embodiment, the relation between the cooling member 332 and the conveyance member preferably is the same as the relation between the heating member 331 and the conveyance member. That is to say, Tp2 represents a projection plane where the cooling region of the cooling member 332 has been projected perpendicularly on the plane where the supporting face S at which the conveyance member (conveyance plate 301) supports the material layer exists, at the layering position. The projection plane Tp2 also has extending regions that extend to and exist at the outer side from both edges of the supporting face S. Accordingly, distortion of the supporting face S of the conveyance member can be suppressed when cooling the material layer supported on the conveyance member by the cooling member 332. Thus, according to the present embodiment, in addition to layering defects due to distortion of the supporting face S when heating, layering defects due to distortion of the supporting face S when cooling can be suppressed as well.

According to the present invention, occurrence of defective layering can be suppressed in the layering forming method where material layers on a conveyance member are heated and layered, and stable forming can be performed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A forming apparatus configured to sequentially layer a plurality of material layers and form a three-dimensional object, the forming apparatus comprising:
a stage having a forming face on which the material layers are layered;
a conveyance member configured to support and convey the material layers to a layering position facing the forming face; and
a heating member configured to nip the material layers between itself and the forming face of the stage at the layering position, and pressurize and heat the material layer,
wherein, when a heating region of the heating member is perpendicularly projected onto a plane where a supporting face at which the conveyance member supports the material layer exists, a projection plane of the heating region has extending regions that extend further to the outer side from both edges of the supporting face, on both edges of the projection plane of the heating region, and
when the stage is perpendicularly projected onto the plane, a projection plane of the stage exists on the inner side of the conveyance member.

2. The forming apparatus according to claim 1, wherein, at the layering position, a largest forming region on the supporting face exists on the inner side of the projection plane of the heating region.

3. The forming apparatus according to claim 2, wherein a length along a straight line connecting the two extending regions of the projection plane of the heating region is 1.05 times or more a length of the supporting face following the straight line.

4. The forming apparatus according to claim 1, further comprising:
a cooling member configured to nip the material layer between itself and the forming face of the stage at the layering position, and cool the material layer,
wherein, when a cooling region of the cooling member is perpendicularly projected onto a plane where a supporting face, at which the conveyance member supports the material layer, exists, a projection plane of the cooling region has extending regions that extend further to the outer side from both edges of the supporting face, on both edges of the projection plane of the cooling region.

5. The forming apparatus according to claim 1, wherein the conveyance member is a rotatable endless belt.

6. The forming apparatus according to claim 5, wherein a length of the heating region of the heating member, in a belt width direction orthogonal to a belt conveyance direction of the endless belt, is larger than a belt width of the endless belt.

7. The forming apparatus according to claim 1, further comprising:
conveyance plate moving means to move the conveyance member that is a plate-shaped conveyance plate.

8. The forming apparatus according to claim 7, wherein the supporting face exists on the inner side of the projection plane of the heating region.

9. The forming apparatus according to claim 1, further comprising:
a material layer forming unit configured to form the material layers,
wherein the material layer forming unit forms the material layers by forming particle images by an electrophotography process.

10. A forming apparatus configured to sequentially layer a plurality of material layers and form a three-dimensional object, the forming apparatus comprising:
a stage having a forming face on which the material layers are sequentially layered;
a rotatable endless belt; and
a heating member configured to come into contact with an inner circumferential face of the endless belt, and nip the material layer supported on an outer circumferential face of the endless belt between the forming face of the stage and the endless belt, and heat the material layer,
wherein a length of a heating region of the heating member in a belt width direction orthogonal to a belt conveyance direction of the endless belt, is larger than a belt width of the endless belt.

11. The forming apparatus according to claim 10, wherein, when a heating region of the heating member is perpendicularly projected onto a plane where a supporting face at which the endless belt supports the material layer exists, a projection plane of the heating region has extending regions that extend further to the outer side from both edges of the supporting face in the belt width direction, on both edges of the projection plane of the heating region.

12. The forming apparatus according to claim 10, wherein a length of the heating region of the heating member in the belt width direction orthogonal to the belt conveyance direction of the endless belt is 1.05 times or more a length of the width of the endless belt.

13. A manufacturing method of a three-dimensional object, to sequentially layer a plurality of material layers and form a three-dimensional object, the manufacturing method comprising:
a conveyance process of supporting and conveying the material layers on a conveyance member;
a heating process of heating the material layers supported on the conveyance member; and
a layering processing of sequentially layering the material layers on the stage,
wherein, in the heating process, the material layers are heated by a region broader than a supporting face where the conveyance member supports the material layers on the supporting face, with regard to at least one direction of conveyance direction of the conveyance member and a direction perpendicular to the conveyance direction.
